(19) United States
(12) Patent Application Publication
(10) Pub. No.: US 2025/0122115 A1
(43) Pub. Date: Apr. 17, 2025

(54) GLASS, OPTICAL FILTER, AND OPTICAL DEVICE

(71) Applicant: AGC Inc., Tokyo (JP)

(72) Inventors: Takahiro SAKAGAMI, Shizuoka (JP); Motoshi NAKAYAMA, Tokyo (JP)

(73) Assignee: AGC Inc., Tokyo (JP)

(21) Appl. No.: 18/999,823

(22) Filed: Dec. 23, 2024

Related U.S. Application Data
(63) Continuation of application No. PCT/JP2023/023361, filed on Jun. 23, 2023.

(30) Foreign Application Priority Data
Jun. 29, 2022 (JP) 2022-104803

(51) Int. Cl. C03C 4/08; C03C 3/062; C03C 3/068; C03C 3/15; C03C 13/04; G02B 5/22

(52) U.S. Cl. CPC C03C 4/082; C03C 3/062; C03C 3/068; C03C 3/15; C03C 13/045; C03C 13/048; G02B 5/226; C03C 2204/00; C03C 2213/00

(57) ABSTRACT

A glass contains ytterbium and has a transmittance of 30% or less for light having a wavelength of 940 nm in terms of a thickness of 0.4 mm. The glass may have a transmittance of 78% or more for light having a wavelength of 850 nm in terms of a thickness of 0.4 mm.

### CROSS-REFERENCE TO RELATED APPLICATIONS

This is a bypass continuation of International Application No. PCT/JP2023/023361 filed on Jun. 23, 2023, and claims priority from Japanese Patent Application No. 2022-104803 filed on Jun. 29, 2022, the entire content of which is incorporated herein by reference.

### TECHNICAL FIELD

The present invention relates to a glass containing ytterbium, and an optical filter and an optical device each including the glass.

### BACKGROUND ART

For an imaging device including a solid state image sensor, an application thereof is extended to a device that takes an image anytime during day and night, such as a monitoring camera or an in-vehicle camera. In such a device, it is necessary to acquire (color) images based on visible light and (monochrome) images based on infrared light.

Therefore, there has been studied use of an optical filter having, in addition to a near infrared ray cut filter function for transmitting visible light and correctly reproducing an image based on the visible light, a function of selectively transmitting a specific near infrared light, that is, a dual band pass filter.

The optical filter has wavelength selectivity when having a function of absorbing specific light and a function of reflecting specific light in response to a change in refractive index.

Here, a light absorbing glass has been studied as a material having a function of absorbing specific light.

Patent Literature 1 discloses glass containing ytterbium (Yb) and having absorption in a near infrared region.

### CITATION LIST

### Patent Literature

Patent Literature 1: WO2016/114274

### SUMMARY OF INVENTION

### Technical Problem

However, the glass described in Patent Literature 1 does not have sufficient absorption in the near infrared region. In order to obtain sufficient absorption, for example, it is necessary to increase a thickness of the glass, but in view of reduction in size and height of camera modules in recent years, mounting may be difficult.

An object of the present invention is to provide a glass containing ytterbium (Yb) and having excellent absorption characteristics in a near infrared region.

### Solution to Problem

The present invention relates to a glass having the following configuration.

[1] A glass containing ytterbium and having a transmittance of 30% or less for light having a wavelength of 940 nm in terms of a thickness of 0.4 mm.

### Advantageous Effects of Invention

The glass of the present invention contains ytterbium (Yb) and has excellent absorption characteristics in a near infrared region. Thus, even when the thickness is small, light in the near infrared region can be sufficiently absorbed.

### BRIEF DESCRIPTION OF DRAWINGS

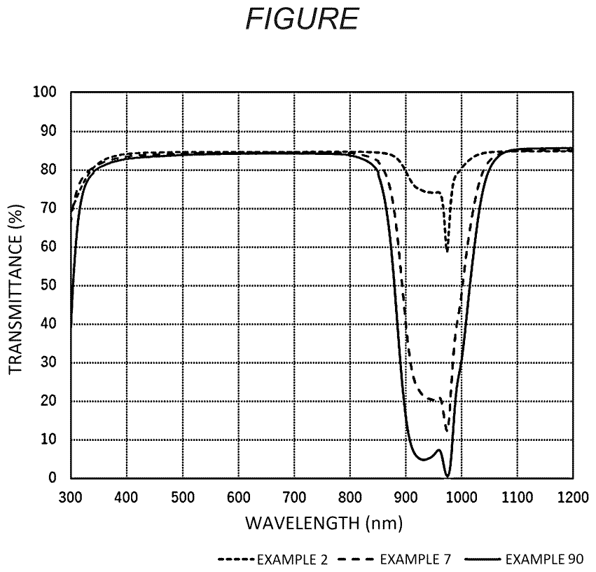

The FIG. 1s a diagram showing spectral transmittance curves of glasses in Examples 7, 90, and 2.

### DESCRIPTION OF EMBODIMENTS

A glass of the present embodiment contains ytterbium (Yb) in a glass composition, and has a transmittance of 30% or less for light having a wavelength of 940 nm in terms of a thickness of 0.4 mm.

An incident direction of light at the time of measurement means a normal direction to a main surface, that is, an incident angle of 0 degrees.

The transmittance of the glass in terms of a thickness of 0.4 mm is calculated by converting a measured transmittance of a glass sample having a predetermined thickness into a transmittance at a thickness of 0.4 mm using the following formula (1), assuming that reflectances of a front surface and a back surface of the glass are each 8.12%. In the formula (1), 0.0812 is used as R from the above reflectances.

Converted transmittance(thickness0.4 mm)=100×(1−R)²×{measured transmittance_{(0deg)}/(100×(1−R)²)}^{(0.4/measured thickness)} Formula (1)

For example, in a sensor that utilizes light having a wavelength of 850 nm, it is required to reliably cut off light outside a wavelength range of 50 nm to 100 nm centered around the wavelength of 850 nm. As a method for cutting off light having a specific wavelength, for example, there has been known an optical filter that utilizes reflection characteristics of a dielectric multilayer film. However, the reflection characteristics of the dielectric multilayer film shift toward a short wavelength side as an incident angle of light to the filter increases, and such a shift in reflection characteristics depending on the incident angle is more noticeable in a long wavelength region. Therefore, there is a risk of adversely affecting transmission characteristics of light having a wavelength of 850 nm.

On the other hand, the glass containing ytterbium absorbs light particularly in a near infrared region having wavelengths of 900 nm to 1000 nm. Further, since an absorption band is steep, transmissivity can be maintained high in regions other than a maximum absorption wavelength region, and transmissivity is excellent in a visible light region and in a near infrared region from visible light to about 800 nm. Since light is cut off by the absorption characteristics, spectral characteristics can reduce the influence of the incident angle unlike the dielectric multilayer film.

When the glass of the present embodiment has the above-described spectral characteristics, in an optical filter mounted on a sensor that utilizes light having a wavelength of 850 nm, unnecessary light having a wavelength longer than 850 nm can be reliably cut off without affecting the transmission characteristics of light having a wavelength of 850 nm. Even when the glass of the present embodiment and the dielectric multilayer film are used in combination, the number of layers of the dielectric multilayer film can be reduced. The glass of the present embodiment can be applied not only to a sensor that utilizes light having a wavelength of 850 nm but also to an optical filter in which a change in spectral characteristics due to an incident angle of light is small in an application of cutting off light having wavelengths around 940 nm.

The glass of the present embodiment has a transmittance of preferably 25% or less, more preferably 15% or less, still more preferably 10% or less, particularly preferably 8% or less, and most preferably 6% or less for light having a wavelength of 940 nm when the thickness thereof is 0.4 mm.

The glass of the present embodiment has a transmittance of preferably 78% or more, more preferably 79% or more, still more preferably 80% or more, even more preferably 81% or more, particularly preferably 82% or more, and most preferably 83% or more for light having a wavelength of 850 nm when the thickness thereof is 0.4 mm.

In the glass of the present embodiment, an absolute value Δλ_{IR50} of a difference between λ_{IRL50} and λ_{IRS50} is preferably 100 nm to 160 nm, where λ_{IRL50} is a wavelength on a long wavelength side and λ_{IRS50} is a wavelength on a short wavelength side among wavelengths at which the transmittance is 50% in a wavelength range of 800 nm to 1100 nm in terms of a thickness of 0.4 mm.

The glass of the present embodiment has such spectral characteristics, and therefore a change in light transmittance is steep (a slope of a relationship between the wavelength and the transmittance is large) from the wavelength of 850 nm to the wavelength of 940 nm. Therefore, for example, in the case of being used as a filter of a solid state image sensor that performs sensing using light having a wavelength of 850 nm, the transmissivity for light having a wavelength of 850 nm can be increased while maintaining a high shielding property of light having wavelengths around 940 nm, which becomes noise, and sensing accuracy can be improved.

Δλ_{IR50} is more preferably 105 nm or more, and still more preferably 110 nm or more, and is more preferably 155 nm or less, and still more preferably 150 nm or less.

The glass of the present embodiment preferably has a transmittance of 80% or more for light having a wavelength of 400 nm when the thickness thereof is 0.4 mm. The glass of the present embodiment has such spectral characteristics, and therefore an image with good color reproducibility can be obtained when the glass is used as a filter of a solid state image sensor that performs imaging using visible light.

The glass of the present embodiment has a transmittance of more preferably 81% or more, still more preferably 82% or more, even more preferably 83% or more, particularly preferably 83.5% or more, and most preferably 84% or more for light having a wavelength of 400 nm when the thickness thereof is 0.4 mm.

The glass of the present embodiment preferably has a Young's modulus of 100 GPa to 150 GPa. The Young's modulus is a physical property serving as an index of strength and hardness of glass. When the Young's modulus is 100 GPa or more, the strength and hardness of the glass are sufficiently high. For example, when the glass is used as an optical filter of a solid state image sensor, the glass can be prevented from being deformed and the optical filter can be prevented from being damaged due to an impact when the imaging device is dropped. When the Young's modulus is 150 GPa or less, the glass is easily processed, and a problem such as an increase in cost at the time of producing the glass is unlikely to occur.

The components that can constitute the glass of the present embodiment and preferred contents thereof (as represented by mol % based on oxides) are described below. In the present description, unless otherwise specified, the content of each component and the total content are represented by mol % based on oxides.

Yb₂O₃ is an essential component for efficiently absorbing light having wavelengths around 900 nm to 1000 nm, particularly light having a wavelength of 940 nm, and for reducing the transmittance. In the glass of the present embodiment, when a content of Yb₂O₃ is 20% or more, an effect thereof can be sufficiently obtained, and when the content is 60% or less, problems such as deterioration in devitrification of the glass, deterioration in meltability, and generation of stray light due to fluorescence are unlikely to occur.

Therefore, the content of Yb₂O₃ is preferably 20% to 60%, more preferably 25% to 60%, still more preferably 30% to 60%, even more preferably 35% to 60%, particularly preferably more than 40% and 60% or less, and most preferably 45% to 60%.

SiO₂ is a main component that forms the glass, and is a component for improving devitrification resistance and viscosity with respect to a liquid phase temperature of the glass. In the glass of the present embodiment, when a content of SiO₂ is 0.1% or more, problems such as instability of the glass, reduction in weather resistance, and generation of striae in the glass are unlikely to occur. When the content of SiO₂ is 50% or less, problems such as deterioration in glass meltability are unlikely to occur.

Therefore, the content of SiO₂ is preferably 0.1% to 50%, more preferably 0.1% to 40%, still more preferably 0.1% to 30%, even more preferably 0.1% to 20%, particularly preferably 0.1% to 10%, and most preferably 0.1% to less than 3%.

B₂O₃ is a main component that forms the glass, and is a component for improving devitrification resistance and viscosity with respect to a liquid phase temperature of the glass. In the glass of the present embodiment, when a content of B₂O₃ is 15% or more, problems such as instability of glass are unlikely to occur. When the content of B₂O₃ is 40% or less, problems such as reduction in weather resistance of the glass and generation of striae in the glass are unlikely to occur.

Therefore, the content of B₂O₃ is preferably 15% to 40%, more preferably 15% to 38%, still more preferably 15% to 36%, even more preferably 15% to 34%, particularly preferably 15% to 32%, and most preferably 15% to 30%.

From the viewpoint of obtaining a stable glass, the glass of the present embodiment preferably contains at least one of SiO₂ and B₂O₃. The total content of the above components is preferably more than 65% from the viewpoint of hardly causing problems such as instability of the glass, and is preferably 80% or less from the viewpoint of hardly causing problems such as deterioration in glass meltability.

Therefore, the total content is more preferably more than 65% and 79% or less, still more preferably more than 65% and 78% or less, even more preferably more than 65% and 77% or less, particularly preferably more than 65% and 76% or less, and most preferably more than 65% and 75% or less.

P₂O₅ is a component for improving meltability and stability of the glass. In the glass of the present embodiment, a content of P₂O₅ is preferably 0% to 15%. When the content of P₂O₅ is 15% or less, problems such as deterioration in weather resistance of the glass, phase separation of the glass, and generation of striae in the glass are unlikely to occur.

The content of P₂O₅ is more preferably 1% to 13%, still more preferably 2% to 12%, even more preferably 3% to 11%, and most preferably 4% to 10%.

GeO₂ is a component for improving devitrification resistance and viscosity with respect to a liquid phase temperature of the glass. In the glass of the present embodiment, a content of GeO₂ is preferably 0% to 15%. When the content of GeO₂ is 15% or less, problems such as deterioration in glass meltability are unlikely to occur.

The content of GeO₂ is more preferably 0% to 13%, further preferably 0% to 11%, still more preferably 0% to 9%, and most preferably 0% to 7%.

Ga₂O₃ is a component for increasing the Young's modulus of the glass and improving meltability and stability. In the glass of the present embodiment, a content of Ga₂O₃ is preferably 0% to 30%. When the content of Ga₂O₃ is 30% or less, problems such as deterioration in devitrification of the glass, an increase in reflectance, and generation of stray light due to reflected light are unlikely to occur.

The content of Ga₂O₃ is more preferably 0.5% to 28%, still more preferably 1% to 26%, even more preferably 2% to 24%, and most preferably 3% to 22%.

ZrO₂ is a component for increasing the Young's modulus of the glass and improving viscosity with respect to a liquid phase temperature of the glass. In the glass of the present embodiment, a content of ZrO₂ is preferably 0% to 7%. When the content of ZrO₂ is 7% or less, problems such as deterioration in devitrification and deterioration in meltability of the glass are unlikely to occur.

The content of ZrO₂ is more preferably 0% to 6%, still more preferably 0% to 5%, even more preferably 0% to 4%, and most preferably 0% to 3%.

La₂O₃ is a component for increasing the Young's modulus of the glass and improving meltability. In the glass of the present embodiment, a content of La₂O₃ is preferably 0.1% to 20%. When the content of La₂O₃ is 0.1% or more, an effect thereof is sufficiently obtained, and when the content is 20% or less, problems such as deterioration in devitrification of the glass, an increase in reflectance, and generation of stray light due to reflected light are unlikely to occur.

The content of La₂O₃ is more preferably 0.5% to 19%, still more preferably 1% to 18%, even more preferably 2% to 17%, and most preferably 2% to 16%.

Al₂O₃ is a component for increasing the Young's modulus of the glass and reducing the refractive index of the glass. In the glass of the present embodiment, a content of Al₂O₃ is preferably 0.1% to 20%. When the content of Al₂O₃ is 0.1% or more, an effect thereof is sufficiently obtained, and when the content is 20% or less, problems such as deterioration in devitrification of the glass, an increase in reflectance, and generation of stray light due to reflected light are unlikely to occur.

The content is more preferably 0.1% to 18%, still more preferably 0.1% to 15%, even more preferably 0.1% to 13%, and most preferably 0.1% to 11%.

A ratio of a total content of components of Al₂O₃, GeO₂, Ga₂O₃, and P₂O₅ to a total content of components of SiO₂ and B₂O₃, that is, (total content of Al₂O₃, GeO₂, Ga₂O₃, and P₂O₅)/(total content of SiO₂ and B₂O₃) is preferably less than 0.1 from the viewpoint of vitrifying glass containing a Yb component without devitrifying the glass.

The glass of the present embodiment may contain an alkali metal oxide, an alkaline earth metal oxide, Sb₂O₃, Cl, F, and other components as long as the object of the present invention is not impaired.

When the glass of the present embodiment is used for an optical filter, it is desirable that reflectance of the glass is reduced in order to prevent an occurrence of stray light due to reflected light on a glass surface. The reflectance of the glass is determined by a refractive index. Typically, a refractive index at a wavelength of 588 nm is preferably 1.700 to 1.900.

When the glass of the present embodiment is used, for example, for an optical filter having, in addition to a near infrared ray cut filter function for transmitting visible light and correctly reproducing an image based on the visible light, a function of selectively transmitting a specific near infrared light, that is, a so-called dual band pass filter, the thickness of the glass is generally 3 mm or less. From the viewpoint of reducing the weight of the component, the thickness thereof is preferably 2 mm or less, more preferably 1 mm or less, still more preferably 0.5 mm or less, and even more preferably 0.3 mm or less. From the viewpoint of ensuring the strength of the glass, the thickness thereof is preferably 0.05 mm or more.

When the glass of the present embodiment is used, for example, for a filter for removal of stray light caused by light having wavelengths around 940 nm, the thickness of the glass is preferably less than 10 mm, more preferably 7 mm or less, still more preferably 4 mm or less, and even more preferably 2 mm or less, from the viewpoint of reducing the weight of the component. From the viewpoint of ensuring the strength of the glass, the thickness thereof is preferably 0.1 mm or more.

The preferred spectral characteristics of the glass of the present embodiment at a thickness of 0.4 mm are described in the description above. Therefore, comparison with a glass having a thickness other than 0.4 mm can be achieved by converting the spectral characteristics of the glass into those of the glass having a thickness of 0.4 mm.

The glass of the present embodiment can be produced, for example, as follows.

First, raw materials are weighed and mixed so as to fall within the above-described composition range (mixing step). The raw material mixture is accommodated in a platinum crucible, and heated and melted at a temperature of 1200° C. to 1650° C. in an electric furnace (melting step). After being sufficiently stirred and refined, the raw material mixture is cast into a mold, cut and polished to form a flat plate having a predetermined thickness (molding step).

In the melting step of the above production method, the highest temperature of the glass during glass melting is preferably 1650° C. or lower. When the highest temperature of the glass during melting is equal to or lower than the above temperature, problems such as crystallization of the glass and generation of un-melted foreign matter in the glass are unlikely to occur. The above temperature is more preferably 1625° C. or lower, and still more preferably 1600° C. or lower.

When the temperature in the melting step is too low, problems such as devitrification occurring during melting and a long time required for burn through may occur, and thus the temperature is preferably 1300° C. or higher, and more preferably 1350° C. or higher.

### <Optical Filter>

An optical filter of the present embodiment preferably includes the glass of the present embodiment.

The optical filter of the present embodiment may further include an optical multilayer film on at least one main surface of the glass of the present embodiment. Examples of the optical multilayer film include an IR cut film (a film reflecting near infrared rays), a UV/IR cut film (a film reflecting ultraviolet rays and near infrared rays), a UV cut film (a film reflecting ultraviolet rays), and an antireflection film. Such an optical multilayer film can be formed by stacking a plurality of dielectric films by a known method such as a vapor deposition method or a sputtering method.

An adhesion reinforcing film may be provided between the glass of the present embodiment and the optical multilayer film. By providing the adhesion reinforcing film, adhesion between the glass and the optical multilayer film can be improved, and film peeling can be prevented. Examples of a substance for forming the adhesion reinforcing film include silicon oxide (SiO₂), titanium oxide (TiO₂), lanthanum titanate (La₂Ti₂O₇), aluminum oxide (Al₂O₃), a mixture of aluminum oxide and zirconium oxide (ZrO₂), magnesium fluoride (MgF₂), calcium fluoride (CaF₂), strontium fluoride (SrF₂), and fluorine silicone. A substance containing fluorine or oxygen has higher adhesion, and magnesium fluoride and/or titanium oxide are particularly preferred as the adhesion reinforcing film since they have high adhesion to the glass and the optical multilayer film. The adhesion reinforcing film may have a single layer or two or more layers. In the case of two or more layers, a plurality of substances may be combined.

The optical filter of the present embodiment may be provided with an absorption layer containing a near infrared absorption dye having a maximum absorption wavelength in the near infrared region, on at least one main surface of the glass of the present embodiment. With such a configuration, an optical filter that keeps a transmittance for light in the near infrared region low can be obtained.

As the near infrared absorption dye, it is preferable to use a near infrared absorption dye consisting of at least one selected from the group consisting of a squarylium dye, a phthalocyanine dye, a cyanine dye, and a diimmonium dye.

The absorption layer preferably contains a near infrared absorption dye and a transparent resin, and the transparent resin is preferably at least one selected from an acrylic resin, an epoxy resin, an ene-thiol resin, a polycarbonate resin, a polyether resin, a polyarylate resin, a polysulfone resin, a polyethersulfone resin, a polyparaphenylene resin, a polyarylene ether phosphine oxide resin, a polyimide resin, a polyamide-imide resin, a polyolefin resin, a cyclic olefin resin, and a polyester resin.

### <Optical Device>

The glass of the present embodiment can be applied to an optical device. The optical device is a device that utilizes light to record and transmit information. Examples of the optical device include an imaging device of a digital still camera and an optical sensor that detects light and converts the light into an electric signal. When the glass of the present embodiment is applied to an optical device, there is an advantage that the glass can contribute to reduction in size and height of the optical device since the glass has excellent absorption characteristics particularly in the near infrared region.

When applied to an optical device, the glass of the present embodiment can be used in combination with an optical filter having light absorption characteristics different from those of the glass of the present embodiment. Examples of the light absorption characteristics of the optical filter include, for example, a characteristic of having an absorption ability in a wavelength range different from that of the glass of the present embodiment, or a characteristic of having a different absorption ability in the same near infrared wavelength range as the glass of the present embodiment. By applying the glass of the present embodiment in combination with an optical filter having different light absorption characteristics in an optical device, optical characteristics that are difficult to obtain with a single glass can be obtained. Examples of the optical filter include an infrared radiation cut filter provided in the vicinity of an imaging element of an imaging device, a cover glass that covers an opening on a cover side of an optical device, and a lens provided inside an optical device. The glass and the optical filter of the present embodiment may be stacked and used.

As described above, the present description discloses the following glass and the like.

[1] A glass containing ytterbium and having a transmittance of 30% or less for light having a wavelength of 940 nm in terms of a thickness of 0.4 mm.

[2] The glass according to [1] having a transmittance of 78% or more for light having a wavelength of 850 nm in terms of a thickness of 0.4 mm.

[3] The glass according to [1] or [2], in which an absolute value Δλ_{IR50} of a difference between λ_{IRL50} and λ_{IRS50} is 100 nm to 160 nm, where Δ_{IRL50} is a wavelength on a long wavelength side and λ_{IRS50} is a wavelength on a short wavelength side among wavelengths at which a transmittance is 50% in a wavelength range of 800 nm to 1100 nm in terms of a thickness of 0.4 mm.

[4] The glass according to any one of [1] to [3] having a Young's modulus of 100 GPa to 150 GPa.

[5] The glass according to any one of [1] to [4], containing 20 mol % or more of Yb₂O₃ as represented by mol % based on oxides.

[6] The glass according to any one of [1] to [5], containing 0.1 mol % to 50 mol % of SiO₂, 15 mol % to 40 mol % of B₂O₃, 0 mol % to 15 mol % of P₂O₅, and 20 mol % to 60 mol % of Yb₂O₃ as represented by mol % based on oxides.

[7] The glass according to any one of [1] to [6], containing 0.1 mol % to 50 mol % of SiO₂, 15 mol % to 40 mol % of B₂O₃, 4 mol % to 10 mol % of P₂O₅, and 20 mol % to 60 mol % of Yb₂O₃ as represented by mol % based on oxides.

[8] The glass according to any one of [1] to [7], containing 20 mol % to 60 mol % of Yb₂O₃, and 0 mol % to 7 mol % of ZrO₂ as represented by mol % based on oxides.

[9] The glass according to any one of [1] to [8], containing 20 mol % to 60 mol % of Yb₂O₃ and 65 mol % or more of a total of SiO₂ and B₂O₃ as represented by mol % based on oxides.

[10] The glass according to any one of [1] to [9], containing 20 mol % to 60 mol % of Yb₂O₃ as represented by mol % based on oxides, wherein (total content of Al₂O₃, GeO₂, Ga₂O₃, and P₂O₅)/(total content of SiO₂ and B₂O₃) is less than 0.1.

[11] The glass according to any one of [1] to [10], containing more than 40 mol % of Yb₂O₃ as represented by mol % based on oxides.

[12] The glass according to any one of [1] to [11], containing 20 mol % to 60 mol % of Yb₂O₃ and 0.1 mol % to 20 mol % of La₂O₃ as represented by mol % based on oxides.

[13] The glass according to any one of [1] to [12], containing 20 mol % to 60 mol % of Yb₂O₃ and 0.1 mol % to 20 mol % of Al₂O₃ as represented by mol % based on oxides.

[14] The glass according to any one of [1] to having a thickness of 0.1 mm or more and less than 10 mm.

[15] The glass according to any one of [1] to [14], in which the glass is used for an optical filter.

[16] An optical filter including the glass according to any one of [1] to [15].

[17] An optical device including the glass according to any one of [1] to [14].

[18] An optical device including: the glass according to any one of [1] to [14]; and an optical filter having a light absorption characteristic different from that of the glass.

### EXAMPLES

Hereinafter, the present invention is described with reference to Examples, but the present invention is not limited to these Examples.

A transmittance of the glass was calculated by converting a measured transmittance of a glass sample having a predetermined thickness at an incidence angle of 0 degrees into a transmittance at a thickness of 0.4 mm using the following formula (1), assuming that reflectances of a front surface and a back surface of the glass were each 8.12%. In the formula (1), 0.0812 was used as R from the above reflectances.

$$Formula ( 1 )$$

$$Converted transmittance ( thickness 0.4 mm ) = 100 \times {( 1 - R )}^{2} \times {\{ measured {transmittance}_{( 0 deg )} / ( 100 \times {( 1 - R )}^{2} ) \}}^{( 0.4 / measured thickness )}$$

### [Production of Glass]

For each of the glass, raw materials were weighed and mixed so as to have a composition (mass % in terms of oxides) shown in Tables 1 to 11, and the mixture was put into a crucible having an inner volume of about 400 cc and melted in an air atmosphere at 1400° C. to 1650° C. for 2 hours. Thereafter, the mixture was refined, stirred, and cast into a rectangular mold of 100 mm length×50 mm width×20 mm height that was preheated to about 300° C. to 500° C., slowly cooled to room temperature at about −1° C./min, and cut into a predetermined thickness within a range of 40 mm length×30 mm width×0.3 mm to 1.5 mm thickness, and both surfaces of the resultant were optically polished to obtain a plate-shaped glass.

The following raw materials were used for each glass.
SiO₂: oxide
B₂O₃: one or more selected from oxide, PBO₄, and H₃BO₃
P₂O₅: one or more of H₃PO₄ and PBO₄
GeO₂: oxide
ZrO₂: oxide
Ga₂O₃: oxide
Yb₂O₃: oxide
La₂O₃: oxide
Al₂O₃: one or more of oxide and Al(OH)₃

The raw materials of the glass are not limited to the above, and known materials can be used.

### [Evaluation]

For each of the glass plates produced as described above, a transmittance (incident angle: 0 degrees) at a wavelength of 300 nm to 1200 nm was measured using a spectrophotometer (V-570, manufactured by JASCO Corporation), and the transmittance was converted into a transmittance at a thickness of 0.4 mm using the above formula (1). From the converted transmittance, a transmittance for light having a wavelength of 940 nm, a transmittance for light having a wavelength of 850 nm, and a transmittance for light having a wavelength of 400 nm were obtained. From the transmittance measured above, transmittance data at intervals of 1 nm from the short wavelength side to the long wavelength side in the wavelength range of 870 nm to 910 nm and the wavelength range of 990 nm to 1030 nm was approximated by a linear expression, the wavelength at which the transmittance was 50% was calculated from the obtained approximate expression, and λ_{IRS50} was the transmittance on the short wavelength side and λ_{IRL50} was the transmittance on the long wavelength side.

The results of the spectral characteristics are shown in Tables 1 to 11.

Examples 1 to 5 are comparative examples, and Examples 6 to 100 are inventive examples.

The transmittance curves of light having wavelengths of 300 nm to 1200 nm for the glasses in Example 7 (Inventive Example), Example 90 (Inventive Example), and Example 2 (Comparative Example) are shown in the FIGURE.

### <Young's Modulus>

A part of the glass samples produced above was measured using an ultrasonic pulse method. The results are shown in Table 12.

### <Refractive Index>

For a part of the glass samples produced above, transmittance and reflectance measurements were performed at incident angles of 0 deg and 30 deg, and a refractive index at a wavelength of 588 nm was determined by a method described in “Optical Thin Film Filter Design” by Mitsunobu Kohiyama (Publisher: OPTRONICS, 2006).

The results are shown in Table 13.

TABLE 1

| | Example | Example | Example | Example | Example | Example | Example | Example | Example | Example |
|---|---|---|---|---|---|---|---|---|---|---|
| | 1 | 2 | 3 | 4 | 5 | 6 | 7 | 8 | 9 | 10 |
| SiO₂ | 3.1 | 0.0 | 66.1 | 48.9 | 0.0 | 41.6 | 32.9 | 41.6 | 32.9 | 32.9 |
| B₂O₃ | 25.2 | 59.2 | 0.0 | 13.5 | 63.0 | 24.0 | 23.2 | 24.0 | 23.2 | 23.2 |
| P₂O₅ | 0.0 | 0.0 | 0.0 | 0.0 | 0.0 | 0.0 | 0.0 | 0.0 | 0.0 | 0.0 |
| Yb₂O₃ | 1.5 | 2.1 | 10.3 | 12.8 | 16.3 | 19.0 | 22.8 | 20.0 | 23.8 | 24.8 |
| GeO₂ | 0.0 | 0.0 | 0.0 | 0.0 | 0.0 | 0.0 | 0.0 | 0.0 | 0.0 | 0.0 |
| Al₂O₃ | 0.0 | 8.1 | 23.6 | 19.6 | 8.1 | 0.0 | 0.0 | 0.0 | 0.0 | 0.0 |
| Na₂O | 0.0 | 0.0 | 0.0 | 3.8 | 0.0 | 0.0 | 0.0 | 0.0 | 0.0 | 0.0 |
| ZnO | 27.9 | 5.1 | 0.0 | 0.0 | 6.7 | 0.0 | 0.0 | 0.0 | 0.0 | 0.0 |
| BaO | 0.0 | 4.5 | 0.0 | 0.0 | 1.8 | 0.0 | 0.0 | 0.0 | 0.0 | 0.0 |
| TiO₂ | 3.0 | 0.0 | 0.0 | 0.0 | 0.0 | 0.0 | 0.0 | 0.0 | 0.0 | 0.0 |
| ZrO₂ | 3.5 | 0.0 | 0.0 | 0.0 | 0.0 | 0.0 | 7.3 | 0.0 | 7.3 | 7.3 |
| WO₃ | 12.9 | 0.0 | 0.0 | 0.0 | 0.0 | 0.0 | 0.0 | 0.0 | 0.0 | 0.0 |
| Ga₂O₃ | 0.0 | 0.0 | 0.0 | 0.0 | 0.0 | 0.0 | 0.0 | 0.0 | 0.0 | 0.0 |
| La₂O₃ | 12.7 | 21.1 | 0.0 | 0.0 | 4.1 | 15.4 | 13.8 | 14.4 | 12.8 | 11.8 |
| Gd₂O₃ | 0.4 | 0.0 | 0.0 | 0.0 | 0.0 | 0.0 | 0.0 | 0.0 | 0.0 | 0.0 |
| Nb₂O₅ | 5.9 | 0.0 | 0.0 | 0.0 | 0.0 | 0.0 | 0.0 | 0.0 | 0.0 | 0.0 |
| Ta₂O₅ | 3.9 | 0.0 | 0.0 | 1.3 | 0.0 | 0.0 | 0.0 | 0.0 | 0.0 | 0.0 |
| Total | 100.0 | 100.0 | 100.0 | 100.0 | 100.0 | 100.0 | 100.0 | 100.0 | 100.0 | 100.0 |
| SiO₂ + B₂O₃ (mol %) | 28.4 | 59.2 | 66.1 | 62.4 | 63.0 | 65.6 | 56.1 | 65.6 | 56.1 | 56.1 |
| (Al₂O₃ + GeO₂ + Ga₂O₃ + | 0.00 | 0.14 | 0.36 | 0.31 | 0.13 | 0.00 | 0.00 | 0.00 | 0.00 | 0.00 |
| P₂O₅)/(SiO₂ + B₂O₃) | | | | | | | | | | |
| Transmittance (%) for | 76.3 | 74.2 | 38.2 | 34.1 | 30.1 | 27.7 | 20.7 | 26.1 | 19.1 | 18.5 |
| light having wavelength | | | | | | | | | | |
| of 940 nm (thickness: 0.4 | | | | | | | | | | |
| mm) | | | | | | | | | | |
| Transmittance (%) for | 84.2 | 84.5 | 84.0 | 84.2 | 84.2 | 83.2 | 82.3 | 83.0 | 81.8 | 82.1 |
| light having wavelength | | | | | | | | | | |
| of 850 nm (thickness: 0.4 | | | | | | | | | | |
| mm) | | | | | | | | | | |
| Transmittance (%) for | 82.8 | 84.1 | 85.5 | 85.3 | 85.4 | 84.1 | 83.4 | 84.1 | 83.5 | 83.5 |
| light having wavelength | | | | | | | | | | |
| of 400 nm (thickness: 0.4 | | | | | | | | | | |
| mm) | | | | | | | | | | |
| Wavelength λ_{IRS50} (nm) | Not | Not | 899.1 | 901.0 | 902.7 | 897.5 | 892.9 | 896.8 | 891.9 | 891.5 |
| at which transmittance is | definable | definable | | | | | | | | |
| 50% on short wavelength | | | | | | | | | | |
| side | | | | | | | | | | |
| Wavelength λ_{IRL50} (nm) | Not | Not | 971.7 | 982.4 | 990.0 | 994.5 | 1001.1 | 996.6 | 1003.0 | 1003.4 |
| at which transmittance is | definable | definable | | | | | | | | |
| 50% on long wavelength | | | | | | | | | | |
| side | | | | | | | | | | |
| λ_{IRL50} − λ_{IRS50} (nm) | — | — | 72.6 | 81.4 | 87.2 | 97.0 | 108.2 | 99.8 | 111.1 | 111.9 |

TABLE 2

| | Example | Example | Example | Example | Example | Example | Example | Example | Example | Example |
|---|---|---|---|---|---|---|---|---|---|---|
| | 11 | 12 | 13 | 14 | 15 | 16 | 17 | 18 | 19 | 20 |
| SiO₂ | 32.9 | 32.9 | 32.3 | 32.6 | 32.9 | 33.6 | 32.9 | 32.9 | 32.9 | 32.9 |
| B₂O₃ | 23.2 | 23.2 | 22.8 | 24.0 | 23.2 | 23.0 | 23.2 | 23.2 | 23.2 | 23.2 |
| P₂O₅ | 0.0 | 0.0 | 0.0 | 0.0 | 0.0 | 0.0 | 0.0 | 0.0 | 0.0 | 0.0 |
| Yb₂O₃ | 25.8 | 26.8 | 26.3 | 26.5 | 26.8 | 26.5 | 26.8 | 26.8 | 26.8 | 27.8 |
| GeO₂ | 0.0 | 0.0 | 0.0 | 0.0 | 0.0 | 0.0 | 0.0 | 0.0 | 0.0 | 0.0 |
| Al₂O₃ | 0.0 | 0.0 | 2.0 | 0.0 | 0.0 | 0.0 | 0.0 | 0.0 | 0.0 | 0.0 |
| Na₂O | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| TiO₂ | 0.0 | 0.0 | 0.0 | 0.0 | 0.0 | 0.0 | 0.0 | 0.0 | 0.0 | 0.0 |
| ZrO₂ | 7.3 | 7.3 | 7.1 | 6.2 | 6.3 | 7.2 | 5.3 | 4.3 | 3.3 | 3.3 |
| WO₃ | 0.0 | 0.0 | 0.0 | 0.0 | 0.0 | 0.0 | 0.0 | 0.0 | 0.0 | 0.0 |
| Ga₂O₃ | 0.0 | 0.0 | 0.0 | 0.0 | 0.0 | 0.0 | 0.0 | 0.0 | 0.0 | 0.0 |
| La₂O₃ | 10.8 | 9.8 | 9.6 | 10.7 | 10.8 | 9.7 | 11.8 | 12.8 | 13.8 | 12.8 |
| Gd₂O₃ | 0.0 | 0.0 | 0.0 | 0.0 | 0.0 | 0.0 | 0.0 | 0.0 | 0.0 | 0.0 |
| Nb₂O₅ | 0.0 | 0.0 | 0.0 | 0.0 | 0.0 | 0.0 | 0.0 | 0.0 | 0.0 | 0.0 |
| Ta₂O₅ | 0.0 | 0.0 | 0.0 | 0.0 | 0.0 | 0.0 | 0.0 | 0.0 | 0.0 | 0.0 |
| Total | 100.0 | 100.0 | 100.0 | 100.0 | 100.0 | 100.0 | 100.0 | 100.0 | 100.0 | 100.0 |
| SiO₂ + B₂O₃ (mol %) | 56.1 | 56.1 | 55.0 | 56.6 | 56.1 | 56.6 | 56.1 | 56.1 | 56.1 | 56.1 |
| (Al₂O₃ + GeO₂ + Ga₂O₃ + | 0.00 | 0.00 | 0.04 | 0.00 | 0.00 | 0.00 | 0.00 | 0.00 | 0.00 | 0.00 |
| P₂O₅)/(SiO₂ + B₂O₃) | | | | | | | | | | |
| Transmittance (%) for | 17.4 | 21.8 | 16.6 | 16.8 | 16.7 | 16.4 | 16.7 | 17.8 | 17.3 | 16.3 |
| light having wavelength | | | | | | | | | | |
| of 940 nm (thickness: 0.4 | | | | | | | | | | |
| mm) | | | | | | | | | | |
| Transmittance (%) for | 81.9 | 82.3 | 81.8 | 81.8 | 81.9 | 81.7 | 81.8 | 82.0 | 81.9 | 81.8 |
| light having wavelength | | | | | | | | | | |
| of 850 nm (thickness: 0.4 | | | | | | | | | | |
| mm) | | | | | | | | | | |
| Transmittance (%) for | 83.4 | 83.4 | 83.4 | 83.2 | 83.5 | 83.3 | 83.4 | 83.5 | 83.3 | 83.3 |
| light having wavelength | | | | | | | | | | |
| of 400 nm (thickness: 0.4 | | | | | | | | | | |
| mm) | | | | | | | | | | |
| Wavelength λ_{IRS50} (nm) | 890.5 | 893.8 | 889.9 | 890.5 | 890.2 | 890.0 | 890.3 | 891.0 | 890.6 | 889.8 |
| at which transmittance is | | | | | | | | | | |
| 50% on short wavelength | | | | | | | | | | |
| side | | | | | | | | | | |
| Wavelength λ_{IRL50} (nm) | 1004.6 | 1000.1 | 1005.3 | 1005.5 | 1005.9 | 1006.0 | 1005.7 | 1004.5 | 1005.0 | 1006.0 |
| at which transmittance is | | | | | | | | | | |
| 50% on long wavelength | | | | | | | | | | |
| side | | | | | | | | | | |
| λ_{IRL50} − λ_{IRS50} (nm) | 114.1 | 106.3 | 115.4 | 115.0 | 115.7 | 116.0 | 115.4 | 113.5 | 114.4 | 116.2 |

TABLE 3

| | Example | Example | Example | Example | Example | Example | Example | Example | Example | Example |
|---|---|---|---|---|---|---|---|---|---|---|
| | 21 | 22 | 23 | 24 | 25 | 26 | 27 | 28 | 29 | 30 |
| SiO₂ | 32.9 | 32.9 | 32.9 | 32.9 | 32.9 | 32.9 | 32.9 | 32.9 | 32.9 | 32.9 |
| B₂O₃ | 23.2 | 23.2 | 23.2 | 23.2 | 23.2 | 23.2 | 23.2 | 29.6 | 28.7 | 26.9 |
| P₂O₅ | 0.0 | 0.0 | 0.0 | 0.0 | 0.0 | 0.0 | 0.0 | 0.0 | 0.0 | 0.0 |
| Yb₂O₃ | 27.8 | 28.8 | 28.8 | 28.8 | 22.8 | 22.8 | 22.8 | 22.8 | 22.8 | 22.8 |
| GeO₂ | 0.0 | 0.0 | 0.0 | 0.0 | 0.0 | 0.0 | 0.0 | 0.0 | 0.0 | 0.0 |
| Al₂O₃ | 0.0 | 0.0 | 0.0 | 0.0 | 0.0 | 0.0 | 0.0 | 0.0 | 0.0 | 0.0 |
| Na₂O | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| TiO₂ | 0.0 | 0.0 | 0.0 | 0.0 | 0.0 | 0.0 | 0.0 | 0.0 | 0.0 | 0.0 |
| ZrO₂ | 2.3 | 1.3 | 0.3 | 0.0 | 3.6 | 1.8 | 0.9 | 0.9 | 1.8 | 3.6 |
| WO₃ | 0.0 | 0.0 | 0.0 | 0.0 | 0.0 | 0.0 | 0.0 | 0.0 | 0.0 | 0.0 |
| Ga₂O₃ | 0.0 | 0.0 | 0.0 | 0.0 | 0.0 | 0.0 | 0.0 | 0.0 | 0.0 | 0.0 |
| La₂O₃ | 13.8 | 13.8 | 14.8 | 15.1 | 17.4 | 19.3 | 20.2 | 13.8 | 13.8 | 13.8 |
| Gd₂O₃ | 0.0 | 0.0 | 0.0 | 0.0 | 0.0 | 0.0 | 0.0 | 0.0 | 0.0 | 0.0 |
| Nb₂O₅ | 0.0 | 0.0 | 0.0 | 0.0 | 0.0 | 0.0 | 0.0 | 0.0 | 0.0 | 0.0 |
| Ta₂O₅ | 0.0 | 0.0 | 0.0 | 0.0 | 0.0 | 0.0 | 0.0 | 0.0 | 0.0 | 0.0 |
| Total | 100.0 | 100.0 | 100.0 | 100.0 | 100.0 | 100.0 | 100.0 | 100.0 | 100.0 | 100.0 |
| SiO₂ + B₂O₃ (mol %) | 56.1 | 56.1 | 56.1 | 56.1 | 56.1 | 56.1 | 56.1 | 62.5 | 61.6 | 59.8 |
| (Al₂O₃ + GeO₂ + Ga₂O₃ + | 0.00 | 0.00 | 0.00 | 0.00 | 0.00 | 0.00 | 0.00 | 0.00 | 0.00 | 0.00 |
| P₂O₅)/(SiO₂ + B₂O₃) | | | | | | | | | | |
| Transmittance (%) for | 16.5 | 15.8 | 16.7 | 16.1 | 20.4 | 21.3 | 21.5 | 21.3 | 21.2 | 20.8 |
| light having wavelength | | | | | | | | | | |
| of 940 nm (thickness: 0.4 | | | | | | | | | | |
| mm) | | | | | | | | | | |
| Transmittance (%) for | 81.8 | 81.7 | 81.8 | 81.7 | 82.2 | 82.2 | 82.3 | 82.6 | 82.5 | 82.2 |
| light having wavelength | | | | | | | | | | |
| of 850 nm (thickness: 0.4 | | | | | | | | | | |
| mm) | | | | | | | | | | |
| Transmittance (%) for | 83.0 | 83.2 | 83.0 | 83.3 | 83.3 | 83.1 | 83.2 | 83.9 | 83.8 | 83.6 |
| light having wavelength | | | | | | | | | | |
| of 400 nm (thickness: 0.4 | | | | | | | | | | |
| mm) | | | | | | | | | | |
| Wavelength λ_{IRS50} (nm) | 890.0 | 889.7 | 890.1 | 889.2 | 893.2 | 893.7 | 893.9 | 894.5 | 894.3 | 893.8 |
| at which transmittance is | | | | | | | | | | |
| 50% on short wavelength | | | | | | | | | | |
| side | | | | | | | | | | |
| Wavelength λ_{IRL50} (nm) | 1006.1 | 1006.6 | 1005.2 | 1006.0 | 1002.2 | 1001.4 | 1001.4 | 1001.5 | 1001.5 | 1001.9 |
| at which transmittance is | | | | | | | | | | |
| 50% on long wavelength | | | | | | | | | | |
| side | | | | | | | | | | |
| λ_{IRL50} − λ_{IRS50} (nm) | 116.1 | 116.9 | 115.0 | 116.8 | 109.0 | 107.7 | 107.5 | 107.0 | 107.2 | 108.1 |

TABLE 4

| | Example | Example | Example | Example | Example | Example | Example | Example | Example | Example |
|---|---|---|---|---|---|---|---|---|---|---|
| | 31 | 32 | 33 | 34 | 35 | 36 | 37 | 38 | 39 | 40 |
| SiO₂ | 32.9 | 32.9 | 32.9 | 32.9 | 15.0 | 15.0 | 32.9 | 32.9 | 32.9 | 32.9 |
| B₂O₃ | 23.2 | 23.2 | 23.2 | 23.2 | 25.0 | 25.0 | 23.2 | 23.2 | 23.2 | 23.2 |
| P₂O₅ | 0.0 | 0.0 | 0.0 | 0.0 | 5.0 | 5.0 | 3.6 | 5.5 | 6.4 | 0.0 |
| Yb₂O₃ | 29.3 | 29.8 | 30.3 | 30.8 | 35.0 | 40.0 | 22.8 | 22.8 | 22.8 | 22.8 |
| GeO₂ | 0.0 | 0.0 | 0.0 | 0.0 | 0.0 | 0.0 | 0.0 | 0.0 | 0.0 | 0.0 |
| Al₂O₃ | 0.0 | 0.0 | 0.0 | 0.0 | 0.0 | 0.0 | 0.0 | 0.0 | 0.0 | 0.0 |
| Na₂O | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| TiO₂ | 0.0 | 0.0 | 0.0 | 0.0 | 0.0 | 0.0 | 0.0 | 0.0 | 0.0 | 0.0 |
| ZrO₂ | 0.3 | 0.3 | 0.3 | 0.3 | 0.0 | 0.0 | 3.6 | 1.8 | 0.9 | 3.6 |
| WO₃ | 0.0 | 0.0 | 0.0 | 0.0 | 0.0 | 0.0 | 0.0 | 0.0 | 0.0 | 0.0 |
| Ga₂O₃ | 0.0 | 0.0 | 0.0 | 0.0 | 20.0 | 15.0 | 0.0 | 0.0 | 0.0 | 3.6 |
| La₂O₃ | 14.3 | 13.8 | 13.3 | 12.8 | 0.0 | 0.0 | 13.8 | 13.8 | 13.8 | 13.8 |
| Gd₂O₃ | 0.0 | 0.0 | 0.0 | 0.0 | 0.0 | 0.0 | 0.0 | 0.0 | 0.0 | 0.0 |
| Nb₂O₅ | 0.0 | 0.0 | 0.0 | 0.0 | 0.0 | 0.0 | 0.0 | 0.0 | 0.0 | 0.0 |
| Ta₂O₅ | 0.0 | 0.0 | 0.0 | 0.0 | 0.0 | 0.0 | 0.0 | 0.0 | 0.0 | 0.0 |
| Total | 100.0 | 100.0 | 100.0 | 100.0 | 100.0 | 100.0 | 100.0 | 100.0 | 100.0 | 100.0 |
| SiO₂ + B₂O₃ (mol %) | 56.1 | 56.1 | 56.1 | 56.1 | 40.0 | 40.0 | 56.1 | 56.1 | 56.1 | 56.1 |
| (Al₂O₃ + GeO₂ + Ga₂O₃ + | 0.00 | 0.00 | 0.00 | 0.00 | 0.63 | 0.50 | 0.06 | 0.10 | 0.11 | 0.06 |
| P₂O₅)/(SiO₂ + B₂O₃) | | | | | | | | | | |
| Transmittance (%) for | 14.1 | 13.4 | 12.4 | 12.9 | 10.3 | 7.5 | 21.3 | 21.8 | 21.5 | 20.4 |
| light having wavelength | | | | | | | | | | |
| of 940 nm (thickness: 0.4 | | | | | | | | | | |
| mm) | | | | | | | | | | |
| Transmittance (%) for | 81.8 | 81.9 | 81.6 | 81.8 | 81.9 | 81.3 | 82.6 | 83.4 | 83.7 | 82.2 |
| light having wavelength | | | | | | | | | | |
| of 850 nm (thickness: 0.4 | | | | | | | | | | |
| mm) | | | | | | | | | | |
| Transmittance (%) for | 82.8 | 83.0 | 82.9 | 83.2 | 83.6 | 83.2 | 83.4 | 83.8 | 84.7 | 83.1 |
| light having wavelength | | | | | | | | | | |
| of 400 nm (thickness: 0.4 | | | | | | | | | | |
| mm) | | | | | | | | | | |
| Wavelength λ_{IRS50} (nm) | 889.1 | 888.6 | 887.8 | 888.1 | 886.2 | 883.5 | 894.2 | 894.6 | 894.5 | 893.1 |
| at which transmittance is | | | | | | | | | | |
| 50% on short wavelength | | | | | | | | | | |
| side | | | | | | | | | | |
| Wavelength λ_{IRL50} (nm) | 1006.9 | 1007.3 | 1008.3 | 1007.9 | 1009.1 | 1011.9 | 1000.4 | 999.4 | 999.7 | 1001.8 |
| at which transmittance is | | | | | | | | | | |
| 50% on long wavelength | | | | | | | | | | |
| side | | | | | | | | | | |
| λ_{IRL50} − λ_{IRS50} (nm) | 117.8 | 118.8 | 120.4 | 119.8 | 122.9 | 128.4 | 106.3 | 104.8 | 105.2 | 108.7 |

TABLE 5

| | Example | Example | Example | Example | Example | Example | Example | Example | Example | Example |
|---|---|---|---|---|---|---|---|---|---|---|
| | 41 | 42 | 43 | 44 | 45 | 46 | 47 | 48 | 49 | 50 |
| SiO₂ | 32.9 | 32.9 | 32.9 | 32.9 | 32.9 | 32.9 | 32.9 | 32.3 | 31.6 | 14.7 |
| B₂O₃ | 23.2 | 23.2 | 23.2 | 23.2 | 23.2 | 23.2 | 23.2 | 22.8 | 22.3 | 24.5 |
| P₂O₅ | 0.0 | 2.0 | 4.0 | 0.0 | 0.0 | 0.0 | 0.0 | 2.0 | 1.9 | 4.9 |
| Yb₂O₃ | 22.8 | 30.3 | 30.3 | 30.3 | 30.3 | 30.3 | 30.3 | 31.7 | 33.0 | 41.2 |
| GeO₂ | 0.0 | 0.0 | 0.0 | 0.0 | 0.0 | 2.0 | 4.0 | 0.0 | 0.0 | 0.0 |
| Al₂O₃ | 0.0 | 0.0 | 0.0 | 0.0 | 0.0 | 0.0 | 0.0 | 0.0 | 0.0 | 0.0 |
| Na₂O | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| TiO₂ | 0.0 | 0.0 | 0.0 | 0.0 | 0.0 | 0.0 | 0.0 | 0.0 | 0.0 | 0.0 |
| ZrO₂ | 1.8 | 0.3 | 0.3 | 0.3 | 0.3 | 0.3 | 0.3 | 0.3 | 0.3 | 0.0 |
| WO₃ | 0.0 | 0.0 | 0.0 | 0.0 | 0.0 | 0.0 | 0.0 | 0.0 | 0.0 | 0.0 |
| Ga₂O₃ | 5.5 | 0.0 | 0.0 | 2.0 | 4.0 | 0.0 | 0.0 | 0.0 | 0.0 | 14.7 |
| La₂O₃ | 13.8 | 11.3 | 9.3 | 11.3 | 9.3 | 11.3 | 9.3 | 11.1 | 10.9 | 0.0 |
| Gd₂O₃ | 0.0 | 0.0 | 0.0 | 0.0 | 0.0 | 0.0 | 0.0 | 0.0 | 0.0 | 0.0 |
| Nb₂O₅ | 0.0 | 0.0 | 0.0 | 0.0 | 0.0 | 0.0 | 0.0 | 0.0 | 0.0 | 0.0 |
| Ta₂O₅ | 0.0 | 0.0 | 0.0 | 0.0 | 0.0 | 0.0 | 0.0 | 0.0 | 0.0 | 0.0 |
| Total | 100.0 | 100.0 | 100.0 | 100.0 | 100.0 | 100.0 | 100.0 | 100.0 | 100.0 | 100.0 |
| SiO₂ + B₂O₃ (mol %) | 56.1 | 56.1 | 56.1 | 56.1 | 56.1 | 56.1 | 56.1 | 55.0 | 54.0 | 39.2 |
| (Al₂O₃ + GeO₂ + Ga₂O₃ + | 0.10 | 0.04 | 0.07 | 0.04 | 0.07 | 0.04 | 0.07 | 0.04 | 0.04 | 0.50 |
| P₂O₅)/(SiO₂ + B₂O₃) | | | | | | | | | | |
| Transmittance (%) for | 22.0 | 14.1 | 13.4 | 12.9 | 12.4 | 12.7 | 13.2 | 12.9 | 11.4 | 7.7 |
| light having wavelength | | | | | | | | | | |
| of 940 nm (thickness: 0.4 | | | | | | | | | | |
| mm) | | | | | | | | | | |
| Transmittance (%) for | 81.2 | 82.4 | 82.5 | 82.1 | 82.2 | 81.8 | 82.0 | 82.1 | 81.6 | 80.9 |
| light having wavelength | | | | | | | | | | |
| of 850 nm (thickness: 0.4 | | | | | | | | | | |
| mm) | | | | | | | | | | |
| Transmittance (%) for | 80.8 | 83.5 | 83.8 | 83.3 | 83.4 | 83.0 | 83.5 | 83.4 | 82.9 | 83.2 |
| light having wavelength | | | | | | | | | | |
| of 400 nm (thickness: 0.4 | | | | | | | | | | |
| mm) | | | | | | | | | | |
| Wavelength λ_{IRS50} (nm) | 894.1 | 889.1 | 888.9 | 888.3 | 887.9 | 888.3 | 888.7 | 888.1 | 886.7 | 883.3 |
| at which transmittance is | | | | | | | | | | |
| 50% on short wavelength | | | | | | | | | | |
| side | | | | | | | | | | |
| Wavelength λ_{IRL50} (nm) | 1000.4 | 1006.1 | 1006.6 | 1007.4 | 1007.8 | 1007.8 | 1007.3 | 1007.1 | 1008.6 | 1011.5 |
| at which transmittance is | | | | | | | | | | |
| 50% on long wavelength | | | | | | | | | | |
| side | | | | | | | | | | |
| λ_{IRL50} − λ_{IRS50} (nm) | 106.3 | 117.0 | 117.7 | 119.1 | 119.9 | 119.6 | 118.6 | 119.0 | 121.9 | 128.2 |

TABLE 6

| | Example | Example | Example | Example | Example | Example | Example | Example | Example | Example |
|---|---|---|---|---|---|---|---|---|---|---|
| | 51 | 52 | 53 | 54 | 55 | 56 | 57 | 58 | 59 | 60 |
| SiO₂ | 14.4 | 30.3 | 29.7 | 13.0 | 11.0 | 14.3 | 14.2 | 13.0 | 11.0 | 28.3 |
| B₂O₃ | 24.0 | 22.8 | 22.3 | 25.0 | 25.0 | 23.8 | 23.6 | 25.0 | 25.0 | 22.8 |
| P₂O₅ | 4.8 | 3.9 | 3.8 | 5.0 | 5.0 | 4.8 | 4.7 | 5.0 | 5.0 | 5.9 |
| Yb₂O₃ | 42.3 | 31.7 | 33.0 | 42.0 | 44.0 | 42.9 | 43.4 | 42.0 | 44.0 | 31.7 |
| GeO₂ | 0.0 | 0.0 | 0.0 | 0.0 | 0.0 | 0.0 | 0.0 | 0.0 | 0.0 | 0.0 |
| Al₂O₃ | 0.0 | 0.0 | 0.0 | 0.0 | 0.0 | 0.0 | 0.0 | 0.0 | 0.0 | 0.0 |
| Na₂O | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| TiO₂ | 0.0 | 0.0 | 0.0 | 0.0 | 0.0 | 0.0 | 0.0 | 0.0 | 0.0 | 0.0 |
| ZrO₂ | 0.0 | 0.3 | 0.3 | 0.0 | 0.0 | 0.0 | 0.0 | 0.0 | 0.0 | 0.3 |
| WO₃ | 0.0 | 0.0 | 0.0 | 0.0 | 0.0 | 0.0 | 0.0 | 0.0 | 0.0 | 0.0 |
| Ga₂O₃ | 14.4 | 0.0 | 0.0 | 15.0 | 15.0 | 14.3 | 14.2 | 7.5 | 7.5 | 0.0 |
| La₂O₃ | 0.0 | 11.1 | 10.9 | 0.0 | 0.0 | 0.0 | 0.0 | 7.5 | 7.5 | 11.1 |
| Gd₂O₃ | 0.0 | 0.0 | 0.0 | 0.0 | 0.0 | 0.0 | 0.0 | 0.0 | 0.0 | 0.0 |
| Nb₂O₅ | 0.0 | 0.0 | 0.0 | 0.0 | 0.0 | 0.0 | 0.0 | 0.0 | 0.0 | 0.0 |
| Ta₂O₅ | 0.0 | 0.0 | 0.0 | 0.0 | 0.0 | 0.0 | 0.0 | 0.0 | 0.0 | 0.0 |
| Total | 100.0 | 100.0 | 100.0 | 100.0 | 100.0 | 100.0 | 100.0 | 100.0 | 100.0 | 100.0 |
| SiO₂ + B₂O₃ (mol %) | 38.5 | 53.1 | 52.0 | 38.0 | 36.0 | 38.1 | 37.7 | 38.0 | 36.0 | 51.1 |
| (Al₂O₃ + GeO₂ + Ga₂O₃ + | 0.50 | 0.07 | 0.07 | 0.53 | 0.56 | 0.50 | 0.50 | 0.33 | 0.35 | 0.12 |
| P₂O₅)/(SiO₂ + B₂O₃) | | | | | | | | | | |
| Transmittance (%) for | 7.1 | 11.4 | 11.5 | 7.2 | 6.0 | 6.3 | 6.3 | 6.9 | 6.4 | 11.5 |
| light having wavelength | | | | | | | | | | |
| of 940 nm (thickness: 0.4 | | | | | | | | | | |
| mm) | | | | | | | | | | |
| Transmittance (%) for | 80.7 | 81.5 | 81.7 | 80.7 | 80.1 | 80.5 | 79.4 | 80.0 | 79.8 | 81.7 |
| light having wavelength | | | | | | | | | | |
| of 850 nm (thickness: 0.4 | | | | | | | | | | |
| mm) | | | | | | | | | | |
| Transmittance (%) for | 83.0 | 83.2 | 83.1 | 83.1 | 82.6 | 83.1 | 81.9 | 82.4 | 82.3 | 83.1 |
| light having wavelength | | | | | | | | | | |
| of 400 nm (thickness: 0.4 | | | | | | | | | | |
| mm) | | | | | | | | | | |
| Wavelength λ_{IRS50} (nm) | 882.3 | 886.7 | 886.6 | 882.6 | 880.9 | 881.1 | 879.2 | 880.7 | 879.3 | 886.8 |
| at which transmittance is | | | | | | | | | | |
| 50% on short wavelength | | | | | | | | | | |
| side | | | | | | | | | | |
| Wavelength λ_{IRL50} (nm) | 1012.2 | 1008.0 | 1007.9 | 1012.1 | 1013.5 | 1013.1 | 1013.2 | 1012.5 | 1013.1 | 1008.0 |
| at which transmittance is | | | | | | | | | | |
| 50% on long wavelength | | | | | | | | | | |
| side | | | | | | | | | | |
| λ_{IRL50} − λ_{IRS50} (nm) | 129.8 | 121.4 | 121.3 | 129.4 | 132.7 | 132.0 | 134.0 | 131.8 | 133.8 | 121.3 |

TABLE 7

| | Example | Example | Example | Example | Example | Example | Example | Example | Example | Example |
|---|---|---|---|---|---|---|---|---|---|---|
| | 61 | 62 | 63 | 64 | 65 | 66 | 67 | 68 | 69 | 70 |
| SiO₂ | 27.8 | 13.0 | 11.0 | 12.5 | 10.6 | 12.5 | 10.6 | 15.0 | 15.0 | 15.0 |
| B₂O₃ | 22.3 | 25.0 | 25.0 | 24.0 | 24.0 | 24.0 | 24.0 | 25.0 | 25.0 | 25.0 |
| P₂O₅ | 5.8 | 5.0 | 5.0 | 4.8 | 4.8 | 4.8 | 4.8 | 5.0 | 5.0 | 7.0 |
| Yb₂O₃ | 33.0 | 42.0 | 44.0 | 44.2 | 46.2 | 44.2 | 46.2 | 40.0 | 40.0 | 35.0 |
| GeO₂ | 0.0 | 0.0 | 0.0 | 0.0 | 0.0 | 0.0 | 0.0 | 0.0 | 0.0 | 0.0 |
| Al₂O₃ | 0.0 | 0.0 | 0.0 | 0.0 | 0.0 | 0.0 | 0.0 | 0.0 | 0.0 | 18.0 |
| Na₂O | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| TiO₂ | 0.0 | 0.0 | 0.0 | 0.0 | 0.0 | 0.0 | 0.0 | 0.0 | 0.0 | 0.0 |
| ZrO₂ | 0.3 | 0.0 | 0.0 | 0.0 | 0.0 | 0.0 | 0.0 | 0.0 | 0.0 | 0.0 |
| WO₃ | 0.0 | 0.0 | 0.0 | 0.0 | 0.0 | 0.0 | 0.0 | 0.0 | 0.0 | 0.0 |
| Ga₂O₃ | 0.0 | 3.8 | 3.8 | 7.2 | 7.2 | 14.4 | 14.4 | 7.5 | 3.8 | 0.0 |
| La₂O₃ | 10.9 | 11.3 | 11.3 | 7.2 | 7.2 | 0.0 | 0.0 | 7.5 | 11.3 | 0.0 |
| Gd₂O₃ | 0.0 | 0.0 | 0.0 | 0.0 | 0.0 | 0.0 | 0.0 | 0.0 | 0.0 | 0.0 |
| Nb₂O₅ | 0.0 | 0.0 | 0.0 | 0.0 | 0.0 | 0.0 | 0.0 | 0.0 | 0.0 | 0.0 |
| Ta₂O₅ | 0.0 | 0.0 | 0.0 | 0.0 | 0.0 | 0.0 | 0.0 | 0.0 | 0.0 | 0.0 |
| Total | 100.0 | 100.0 | 100.0 | 100.0 | 100.0 | 100.0 | 100.0 | 100.0 | 100.0 | 100.0 |
| SiO₂ + B₂O₃ (mol %) | 50.1 | 38.0 | 36.0 | 36.5 | 34.6 | 36.5 | 34.6 | 40.0 | 40.0 | 40.0 |
| (Al₂O₃ + GeO₂ + Ga₂O₃ + | 0.12 | 0.23 | 0.24 | 0.33 | 0.35 | 0.53 | 0.56 | 0.31 | 0.22 | 0.63 |
| P₂O₅)/(SiO₂ + B₂O₃) | | | | | | | | | | |
| Transmittance (%) for | 11.7 | 7.3 | 6.4 | 6.3 | 5.6 | 6.0 | 5.5 | 7.6 | 8.2 | 11.8 |
| light having wavelength | | | | | | | | | | |
| of 940 nm (thickness: 0.4 | | | | | | | | | | |
| mm) | | | | | | | | | | |
| Transmittance (%) for | 82.0 | 79.5 | 79.1 | 79.7 | 79.0 | 80.0 | 79.7 | 80.4 | 80.2 | 82.4 |
| light having wavelength | | | | | | | | | | |
| of 850 nm (thickness: 0.4 | | | | | | | | | | |
| mm) | | | | | | | | | | |
| Transmittance (%) for | 83.5 | 81.8 | 81.6 | 82.4 | 81.9 | 82.6 | 82.5 | 82.0 | 82.3 | 84.4 |
| light having wavelength | | | | | | | | | | |
| of 400 nm (thickness: 0.4 | | | | | | | | | | |
| mm) | | | | | | | | | | |
| Wavelength λ_{IRS50} (nm) | 887.0 | 880.1 | 877.8 | 878.7 | 877.4 | 880.1 | 879.3 | 881.8 | 881.8 | 885.9 |
| at which transmittance is | | | | | | | | | | |
| 50% on short wavelength | | | | | | | | | | |
| side | | | | | | | | | | |
| Wavelength λ_{IRL50} (nm) | 1007.9 | 1012.0 | 1013.0 | 1013.2 | 1014.2 | 1013.7 | 1014.3 | 1011.7 | 1011.1 | 1006.8 |
| at which transmittance is | | | | | | | | | | |
| 50% on long wavelength | | | | | | | | | | |
| side | | | | | | | | | | |
| λ_{IRL50} − λ_{IRS50} (nm) | 120.9 | 131.9 | 135.2 | 134.5 | 136.9 | 133.7 | 135.0 | 129.9 | 129.3 | 120.9 |

TABLE 8

| | Example | Example | Example | Example | Example | Example | Example | Example | Example | Example |
|---|---|---|---|---|---|---|---|---|---|---|
| | 71 | 72 | 73 | 74 | 75 | 76 | 77 | 78 | 79 | 80 |
| SiO₂ | 15.0 | 15.0 | 15.0 | 13.0 | 13.0 | 15.0 | 13.0 | 11.0 | 26.8 | 25.9 |
| B₂O₃ | 25.0 | 25.0 | 25.0 | 25.0 | 25.0 | 25.0 | 25.0 | 25.0 | 22.3 | 22.3 |
| P₂O₅ | 7.0 | 5.0 | 5.0 | 7.0 | 7.0 | 5.0 | 7.0 | 9.0 | 5.8 | 5.8 |
| Yb₂O₃ | 40.0 | 35.0 | 40.0 | 35.0 | 40.0 | 40.0 | 40.0 | 40.0 | 33.9 | 34.9 |
| GeO₂ | 0.0 | 0.0 | 0.0 | 0.0 | 0.0 | 0.0 | 0.0 | 0.0 | 0.0 | 0.0 |
| Al₂O₃ | 13.0 | 20.0 | 15.0 | 20.0 | 15.0 | 0.0 | 0.0 | 0.0 | 0.0 | 0.0 |
| Na₂O | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| TiO₂ | 0.0 | 0.0 | 0.0 | 0.0 | 0.0 | 0.0 | 0.0 | 0.0 | 0.0 | 0.0 |
| ZrO₂ | 0.0 | 0.0 | 0.0 | 0.0 | 0.0 | 0.0 | 0.0 | 0.0 | 0.3 | 0.3 |
| WO₃ | 0.0 | 0.0 | 0.0 | 0.0 | 0.0 | 0.0 | 0.0 | 0.0 | 0.0 | 0.0 |
| Ga₂O₃ | 0.0 | 0.0 | 0.0 | 0.0 | 0.0 | 0.0 | 0.0 | 0.0 | 0.0 | 0.0 |
| La₂O₃ | 0.0 | 0.0 | 0.0 | 0.0 | 0.0 | 15.0 | 15.0 | 15.0 | 10.9 | 10.9 |
| Gd₂O₃ | 0.0 | 0.0 | 0.0 | 0.0 | 0.0 | 0.0 | 0.0 | 0.0 | 0.0 | 0.0 |
| Nb₂O₅ | 0.0 | 0.0 | 0.0 | 0.0 | 0.0 | 0.0 | 0.0 | 0.0 | 0.0 | 0.0 |
| Ta₂O₅ | 0.0 | 0.0 | 0.0 | 0.0 | 0.0 | 0.0 | 0.0 | 0.0 | 0.0 | 0.0 |
| Total | 100.0 | 100.0 | 100.0 | 100.0 | 100.0 | 100.0 | 100.0 | 100.0 | 100.0 | 100.0 |
| SiO₂ + B₂O₃ (mol %) | 40.0 | 40.0 | 40.0 | 38.0 | 38.0 | 40.0 | 38.0 | 36.0 | 49.2 | 48.2 |
| (Al₂O₃ + GeO₂ + Ga₂O₃ + | 0.50 | 0.63 | 0.50 | 0.71 | 0.58 | 0.13 | 0.18 | 0.25 | 0.12 | 0.12 |
| P₂O₅)/(SiO₂ + B₂O₃) | | | | | | | | | | |
| Transmittance (%) for | 8.4 | 10.3 | 8.4 | 11.3 | 8.9 | 8.2 | 8.0 | 8.4 | 11.0 | 10.9 |
| light having wavelength | | | | | | | | | | |
| of 940 nm (thickness: 0.4 | | | | | | | | | | |
| mm) | | | | | | | | | | |
| Transmittance (%) for | 81.5 | 82.2 | 81.8 | 82.7 | 81.9 | 79.4 | 79.3 | 79.9 | 81.6 | 81.5 |
| light having wavelength | | | | | | | | | | |
| of 850 nm (thickness: 0.4 | | | | | | | | | | |
| mm) | | | | | | | | | | |
| Transmittance (%) for | 83.8 | 84.4 | 84.1 | 84.5 | 84.2 | 81.8 | 81.8 | 82.3 | 83.2 | 83.1 |
| light having wavelength | | | | | | | | | | |
| of 400 nm (thickness: 0.4 | | | | | | | | | | |
| mm) | | | | | | | | | | |
| Wavelength λ_{IRS50} (nm) | 882.7 | 884.3 | 882.5 | 885.2 | 882.8 | 879.7 | 879.1 | 879.6 | 886.0 | 886.0 |
| at which transmittance is | | | | | | | | | | |
| 50% on short wavelength | | | | | | | | | | |
| side | | | | | | | | | | |
| Wavelength λ_{IRL50} (nm) | 1010.1 | 1007.9 | 1010.1 | 1006.7 | 1009.4 | 1010.7 | 1010.8 | 1010.4 | 1008.6 | 1008.7 |
| at which transmittance is | | | | | | | | | | |
| 50% on long wavelength | | | | | | | | | | |
| side | | | | | | | | | | |
| λ_{IRL50} − λ_{IRS50} (nm) | 127.4 | 123.6 | 127.6 | 121.5 | 126.6 | 131.0 | 131.7 | 130.8 | 122.6 | 122.7 |

TABLE 9

| | Example | Example | Example | Example | Example | Example | Example | Example | Example | Example |
|---|---|---|---|---|---|---|---|---|---|---|
| | 81 | 82 | 83 | 84 | 85 | 86 | 87 | 88 | 89 | 90 |
| SiO₂ | 24.9 | 15.0 | 15.0 | 15.0 | 9.6 | 8.7 | 7.7 | 9.4 | 8.5 | 7.5 |
| B₂O₃ | 22.3 | 24.0 | 23.0 | 22.0 | 24.0 | 24.0 | 24.0 | 23.6 | 23.6 | 23.6 |
| P₂O₅ | 5.8 | 6.0 | 7.0 | 8.0 | 5.8 | 6.7 | 7.7 | 5.7 | 6.6 | 7.5 |
| Yb₂O₃ | 35.9 | 40.0 | 40.0 | 40.0 | 46.2 | 46.2 | 46.2 | 47.2 | 47.2 | 47.2 |
| GeO₂ | 0.0 | 0.0 | 0.0 | 0.0 | 0.0 | 0.0 | 0.0 | 0.0 | 0.0 | 0.0 |
| Al₂O₃ | 0.0 | 0.0 | 0.0 | 0.0 | 0.0 | 0.0 | 0.0 | 0.0 | 0.0 | 0.0 |
| Na₂O | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| TiO₂ | 0.0 | 0.0 | 0.0 | 0.0 | 0.0 | 0.0 | 0.0 | 0.0 | 0.0 | 0.0 |
| ZrO₂ | 0.3 | 0.0 | 0.0 | 0.0 | 0.0 | 0.0 | 0.0 | 0.0 | 0.0 | 0.0 |
| WO₃ | 0.0 | 0.0 | 0.0 | 0.0 | 0.0 | 0.0 | 0.0 | 0.0 | 0.0 | 0.0 |
| Ga₂O₃ | 0.0 | 0.0 | 0.0 | 0.0 | 14.4 | 14.4 | 14.4 | 14.2 | 14.2 | 14.2 |
| La₂O₃ | 10.9 | 15.0 | 15.0 | 15.0 | 0.0 | 0.0 | 0.0 | 0.0 | 0.0 | 0.0 |
| Gd₂O₃ | 0.0 | 0.0 | 0.0 | 0.0 | 0.0 | 0.0 | 0.0 | 0.0 | 0.0 | 0.0 |
| Nb₂O₅ | 0.0 | 0.0 | 0.0 | 0.0 | 0.0 | 0.0 | 0.0 | 0.0 | 0.0 | 0.0 |
| Ta₂O₅ | 0.0 | 0.0 | 0.0 | 0.0 | 0.0 | 0.0 | 0.0 | 0.0 | 0.0 | 0.0 |
| Total | 100.0 | 100.0 | 100.0 | 100.0 | 100.0 | 100.0 | 100.0 | 100.0 | 100.0 | 100.0 |
| SiO₂ + B₂O₃ (mol %) | 47.2 | 39.0 | 38.0 | 37.0 | 33.7 | 32.7 | 31.7 | 33.0 | 32.1 | 31.1 |
| (Al₂O₃ + GeO₂ + Ga₂O₃ + | 0.12 | 0.15 | 0.18 | 0.22 | 0.60 | 0.65 | 0.70 | 0.60 | 0.65 | 0.70 |
| P₂O₅)/(SiO₂ + B₂O₃) | | | | | | | | | | |
| Transmittance (%) for | 10.0 | 7.9 | 8.2 | 8.4 | 6.0 | 5.6 | 5.8 | 5.2 | 5.0 | 5.1 |
| light having wavelength | | | | | | | | | | |
| of 940 nm (thickness: 0.4 | | | | | | | | | | |
| mm) | | | | | | | | | | |
| Transmittance (%) for | 81.0 | 79.1 | 79.2 | 79.4 | 79.6 | 79.5 | 79.9 | 79.6 | 79.6 | 79.6 |
| light having wavelength | | | | | | | | | | |
| of 850 nm (thickness: 0.4 | | | | | | | | | | |
| mm) | | | | | | | | | | |
| Transmittance (%) for | 82.8 | 81.5 | 81.7 | 81.8 | 82.3 | 82.3 | 82.7 | 82.8 | 83.1 | 82.9 |
| light having wavelength | | | | | | | | | | |
| of 400 nm (thickness: 0.4 | | | | | | | | | | |
| mm) | | | | | | | | | | |
| Wavelength λ_{IRS50} (nm) | 884.4 | 878.5 | 878.7 | 878.7 | 879.4 | 879.4 | 879.7 | 878.7 | 878.4 | 878.7 |
| at which transmittance is | | | | | | | | | | |
| 50% on short wavelength | | | | | | | | | | |
| side | | | | | | | | | | |
| Wavelength λ_{IRL50} (nm) | 1009.0 | 1010.7 | 1010.4 | 1010.0 | 1013.3 | 1013.7 | 1013.5 | 1014.5 | 1014.8 | 1014.5 |
| at which transmittance is | | | | | | | | | | |
| 50% on long wavelength | | | | | | | | | | |
| side | | | | | | | | | | |
| λ_{IRL50} − λ_{IRS50} (nm) | 124.6 | 132.2 | 131.7 | 131.3 | 133.9 | 134.3 | 133.8 | 135.8 | 136.4 | 135.8 |

TABLE 10

| | Example | Example | Example | Example | Example | Example |
|---|---|---|---|---|---|---|
| | 91 | 92 | 93 | 94 | 95 | 96 |
| SiO₂ | 10.0 | 9.0 | 8.0 | 14.0 | 13.0 | 12.0 |
| B₂O₃ | 25.0 | 25.0 | 25.0 | 26.0 | 27.0 | 28.0 |
| P₂O₅ | 10.0 | 11.0 | 12.0 | 5.0 | 5.0 | 5.0 |
| Yb₂O₃ | 40.0 | 40.0 | 40.0 | 40.0 | 40.0 | 40.0 |
| GeO₂ | 0.0 | 0.0 | 0.0 | 0.0 | 0.0 | 0.0 |
| Al₂O₃ | 0.0 | 0.0 | 0.0 | 0.0 | 0.0 | 0.0 |
| Na₂O | 0.0 | 0.0 | 0.0 | 0.0 | 0.0 | 0.0 |
| ZnO | 0.0 | 0.0 | 0.0 | 0.0 | 0.0 | 0.0 |
| BaO | 0.0 | 0.0 | 0.0 | 0.0 | 0.0 | 0.0 |
| TiO₂ | 0.0 | 0.0 | 0.0 | 0.0 | 0.0 | 0.0 |
| ZrO₂ | 0.0 | 0.0 | 0.0 | 0.0 | 0.0 | 0.0 |
| WO₃ | 0.0 | 0.0 | 0.0 | 0.0 | 0.0 | 0.0 |
| Ga₂O₃ | 0.0 | 0.0 | 0.0 | 0.0 | 0.0 | 0.0 |
| La₂O₃ | 15.0 | 15.0 | 15.0 | 15.0 | 15.0 | 15.0 |
| Gd₂O₃ | 0.0 | 0.0 | 0.0 | 0.0 | 0.0 | 0.0 |
| Nb₂O₅ | 0.0 | 0.0 | 0.0 | 0.0 | 0.0 | 0.0 |
| Ta₂O₅ | 0.0 | 0.0 | 0.0 | 0.0 | 0.0 | 0.0 |
| Total | 100.0 | 100.0 | 100.0 | 100.0 | 100.0 | 100.0 |
| SiO₂ + B₂O₃ (mol %) | 35.0 | 34.0 | 33.0 | 40.0 | 40.0 | 40.0 |
| (Al₂O₃ + GeO₂ + Ga₂O₃ + | 0.29 | 0.32 | 0.36 | 0.13 | 0.13 | 0.13 |
| P₂O₅)/(SiO₂ + B₂O₃) | | | | | | |
| Transmittance (%) for | 8.2 | 8.8 | 9.0 | 8.0 | 8.0 | 8.0 |
| light having wavelength | | | | | | |
| of 940 nm (thickness: 0.4 | | | | | | |
| mm) | | | | | | |
| Transmittance (%) for | 79.9 | 79.8 | 79.9 | 79.6 | 79.6 | 79.8 |
| light having wavelength | | | | | | |
| of 850 nm (thickness: 0.4 | | | | | | |
| mm) | | | | | | |
| Transmittance (%) for | 82.5 | 82.1 | 82.1 | 81.8 | 81.9 | 81.9 |
| light having wavelength | | | | | | |
| of 400 nm (thickness: 0.4 | | | | | | |
| mm) | | | | | | |
| Wavelength λ_{IRS50} (nm) | 880.1 | 880.4 | 880.6 | 879.3 | 879.6 | 879.8 |
| at which transmittance is | | | | | | |
| 50% on short wavelength | | | | | | |
| side | | | | | | |
| Wavelength λ_{IRL50} (nm) | 1010.6 | 1009.8 | 1009.6 | 1010.9 | 1011.0 | 1011.0 |
| at which transmittance is | | | | | | |
| 50% on long wavelength | | | | | | |
| side | | | | | | |
| λ_{IRL50} − λ_{IRS50} (nm) | 130.5 | 129.4 | 129.0 | 131.6 | 131.4 | 131.2 |

TABLE 11

| | Example | Example | Example | Example |
|---|---|---|---|---|
| | 97 | 98 | 99 | 100 |
| SiO₂ | 7.4 | 7.3 | 7.1 | 6.9 |
| B₂O₃ | 23.1 | 22.7 | 22.3 | 21.6 |
| P₂O₅ | 7.4 | 7.3 | 7.1 | 6.9 |
| Yb₂O₃ | 48.1 | 49.1 | 50.0 | 51.7 |
| GeO₂ | 0.0 | 0.0 | 0.0 | 0.0 |
| Al₂O₃ | 0.0 | 0.0 | 0.0 | 0.0 |
| Na₂O | 0.0 | 0.0 | 0.0 | 0.0 |
| ZnO | 0.0 | 0.0 | 0.0 | 0.0 |
| BaO | 0.0 | 0.0 | 0.0 | 0.0 |
| TiO₂ | 0.0 | 0.0 | 0.0 | 0.0 |
| ZrO₂ | 0.0 | 0.0 | 0.0 | 0.0 |
| WO₃ | 0.0 | 0.0 | 0.0 | 0.0 |
| Ga₂O₃ | 9.7 | 9.5 | 9.4 | 9.1 |
| La₂O₃ | 4.2 | 4.1 | 4.0 | 3.9 |
| Gd₂O₃ | 0.0 | 0.0 | 0.0 | 0.0 |
| Nb₂O₅ | 0.0 | 0.0 | 0.0 | 0.0 |
| Ta₂O₅ | 0.0 | 0.0 | 0.0 | 0.0 |
| Total | 100.0 | 100.0 | 100.0 | 100.0 |
| SiO₂ + B₂O₃ (mol %) | 30.6 | 30.0 | 29.5 | 28.4 |
| (Al₂O₃ + GcO₂ + | 0.56 | 0.56 | 0.56 | 0.56 |
| Ga₂O₃ + P₂O₅)/(SiO₂ + | | | | |
| B₂O₃) | | | | |
| Transmittance (%) for | 4.9 | 4.4 | 4.3 | 3.8 |
| light having wavelength | | | | |
| of 940 nm (thickness: | | | | |
| 0.4 mm) | | | | |
| Transmittance (%) for | 78.9 | 78.6 | 78.2 | 77.8 |
| light having wavelength | | | | |
| of 850 nm (thickness: | | | | |
| 0.4 mm) | | | | |
| Transmittance (%) for | 81.5 | 81.2 | 81.1 | 80.9 |
| light having wavelength | | | | |
| of 400 nm (thickness: | | | | |
| 0.4 mm) | | | | |
| Wavelength λ_{IRS50} (nm) | 879.2 | 878.1 | 877.7 | 876.3 |
| at which transmittance | | | | |
| is 50% on short | | | | |
| wavelength side | | | | |
| Wavelength λ_{IRL50} (nm) | 1016.6 | 1017.3 | 1017.4 | 1018.1 |
| at which transmittance | | | | |
| is 50% on long | | | | |
| wavelength side | | | | |
| λ_{IRL50} − λ_{IRS50} (nm) | 130.5 | 129.4 | 129.0 | 131.2 |

TABLE 12

| | Young's modulus (GPa) |
|---|---|
| Example 6 | 117.4 |
| Example 7 | 131.6 |
| Example 35 | 123.8 |
| Example 36 | 124.7 |
| Example 58 | 125.3 |
| Example 67 | 130.6 |
| Example 68 | 124.5 |
| Example 69 | 124.7 |
| Example 72 | 122.9 |
| Example 73 | 130.4 |
| Example 76 | 123.9 |
| Example 78 | 115.1 |
| Example 81 | 121.0 |
| Example 90 | 130.5 |

TABLE 13

| | Refractive index |
|---|---|
| Example 35 | 1.795 |
| Example 36 | 1.804 |
| Example 72 | 1.754 |
| Example 73 | 1.773 |

From the above results, it is understood that the glasses in Examples 6 to 100 each had a transmittance of 30% or less for light having a wavelength of 940 nm when the thickness thereof is 0.4 mm, and were excellent in shielding property for near infrared light.

Although the present invention has been described in detail with reference to specific embodiments, it is apparent to those skilled in the art that various changes and modifications can be made without departing from the spirit and scope of the present invention. The present application is based on a Japanese Patent Application (Japanese Patent Application No. 2022-104803) filed on Jun. 29, 2022, the content of which is incorporated herein by reference.

### INDUSTRIAL APPLICABILITY

The glass according to the embodiment of the present invention has excellent absorption characteristics for specific near infrared light. Such a glass is useful for an optical filter in an imaging device such as a camera and a sensor for transport aircraft, the performance of which has been improving in recent years.

1. A glass comprising ytterbium and having a transmittance of 30% or less for light having a wavelength of 940 nm in terms of a thickness of 0.4 mm.

2. The glass according to claim 1, having a transmittance of 78% or more for light having a wavelength of 850 nm in terms of a thickness of 0.4 mm.

3. The glass according to claim 1, wherein an absolute value Δλ_{IR50} of a difference between λ_{IRL50} and λ_{IRS50} is 100 nm to 160 nm, wherein λ_{IRL50} is a wavelength on a long wavelength side and λ_{IRS50} is a wavelength on a short wavelength side among wavelengths at which a transmittance is 50% in a wavelength range of 800 nm to 1100 nm in terms of a thickness of 0.4 mm.

4. The glass according to claim 1, having a Young's modulus of 100 GPa to 150 GPa.

5. The glass according to claim 1, comprising 20 mol % or more of Yb₂O₃ as represented by mol % based on oxides.

6. The glass according to claim 1, comprising, as represented by mol % based on oxides,
0.1 mol % to 50 mol % of SiO₂,
15 mol % to 40 mol % of B₂O₃,
0 mol % to 15 mol % of P₂O₅, and
20 mol % to 60 mol % of Yb₂O₃.

7. The glass according to claim 1, comprising, as represented by mol % based on oxides,
0.1 mol % to 50 mol % of SiO₂,
15 mol % to 40 mol % of B₂O₃,
4 mol % to 10 mol % of P₂O₅, and
20 mol % to 60 mol % of Yb₂O₃.

8. The glass according to claim 1, comprising, as represented by mol % based on oxides,
20 mol % to 60 mol % of Yb₂O₃, and
0 mol % to 7 mol % of ZrO₂.

9. The glass according to claim 1, comprising, as represented by mol % based on oxides,
20 mol % to 60 mol % of Yb₂O₃, and
65 mol % or more of a total of SiO₂ and B₂O₃.

10. The glass according to claim 1, comprising 20 mol % to 60 mol % of Yb₂O₃ as represented by mol % based on oxides,
wherein (total content of Al₂O₃, GeO₂, Ga₂₀₃, and P₂O₅)/(total content of SiO₂ and B₂O₃) is less than 0.1.

11. The glass according to claim 1, comprising more than 40 mol % of Yb₂O₃ as represented by mol % based on oxides.

12. The glass according to claim 1, comprising, as represented by mol % based on oxides,
20 mol % to 60 mol % of Yb₂O₃, and
0.1 mol % to 20 mol % of La₂O₃.

13. The glass according to claim 1, comprising, as represented by mol % based on oxides,
20 mol % to 60 mol % of Yb₂O₃, and
0.1 mol % to 20 mol % of Al₂O₃.

14. The glass according to claim 1, having a thickness of 0.1 mm or more and less than 10 mm.

15. The glass according to claim 1, wherein the glass is used for an optical filter.

16. An optical filter comprising the glass according to claim 1.

17. An optical device comprising the glass according to claim 1.

18. An optical device comprising: the glass according to claim 1; and an optical filter having a light absorption characteristic different from that of the glass.
